(19) United States
(12) Patent Application Publication
(10) Pub. No.: US 2025/0030642 A1
(43) Pub. Date: Jan. 23, 2025

(54) PACKET CONTROL SYSTEM, PACKET CONTROL METHOD, AND PACKET CONTROL APPARATUS

(71) Applicant: NEC Corporation, Minato-ku, Tokyo (JP)

(72) Inventors: Anan SAWABE, Tokyo (JP); Yusuke Shinohara, Tokyo (JP)

(73) Assignee: NEC Corporation, Minato-ku, Tokyo (JP)

(21) Appl. No.: 18/024,709

(22) PCT Filed: Jun. 30, 2022
(86) PCT No.: PCT/JP2022/026313

§ 371 Date: Mar. 3, 2023

(51) Int. Cl. H04L 47/52; H04L 43/0852

(52) U.S. Cl. CPC H04L 47/52; H04L 43/0852

(57) ABSTRACT

In order to strategically utilize a network even when a band usable for the network varies, a packet control system (1) includes: an acquisition unit (11) that acquires a packet associated with a sending timing; an enqueue unit (12) that enqueues the packet into any of a plurality of queues in accordance with the sending timing associated with the packet; and a sending unit (17) that dequeues a packet from each of the plurality of queues in accordance with a dequeue timing specified for the queue and that sends the packet to a network. The number of packets to be sent to the network by the sending unit (17) is restricted in accordance with a band usable for the network, and the sending unit (17) sends, after the sending timing associated with the packet, a packet that is not sent at the sending timing.

### TECHNICAL FIELD

The present invention relates to a technique for controlling packets.

### BACKGROUND ART

A technique in which transmission control of packets is carried out using a plurality of queues has been proposed. For example, Patent Literature 1 discloses a relay apparatus in which packets are distributed and stored in any of a plurality of queues in accordance with values that have been obtained by a predetermined function from delivery information pertaining of to delivery communication packets, and the packets are outputted while a band for each queue is controlled. Patent Literature 2 indicates that packets are distributed to queues in accordance with types of the packets, a scheduled transmission time is determined in accordance with a quality of service (QOS) value set for each of the queues, and the packets are outputted.

### CITATION LIST

### Patent Literature

### [Patent Literature 1]

Japanese Patent Application Publication Tokukai No. 2013-34164

### [Patent Literature 2]

Japanese Patent Application Publication Tokukai No. 2011-24027

### SUMMARY OF INVENTION

### Technical Problem

In the techniques disclosed in Patent Literatures 1 and 2, there is a problem that, in a case where a band that is usable for a network varies, a delay and a delay jitter are rapidly increased due to occurrence of an instantaneous overload.

An example aspect of the present invention is attained in view of the problem, and an example object is to provide a packet control technique that can strategically utilize a network even in a case where a band that is usable for the network varies.

### Solution to Problem

A packet control system according to an example aspect of the present invention includes: an acquisition section that acquires a packet which is associated with a sending timing; an enqueue section that enqueues the packet into any of a plurality of queues in accordance with the sending timing which is associated with the packet; and a sending section that dequeues a packet from each of the plurality of queues in accordance with a dequeue timing specified for the queue and that sends the packet to a network, the number of packets to be sent to the network by the sending section being restricted in accordance with a band that is usable for the network, and the sending section sending, after the sending timing associated with the packet, a packet that is not sent at the sending timing.

A packet control method according to an example aspect of the present invention includes: acquiring a packet which is associated with a sending timing; enqueuing the packet into any of a plurality of queues in accordance with the sending timing which is associated with the packet; and dequeuing a packet from each of the plurality of queues in accordance with a dequeue timing specified for the queue and sending the packet to a network, the number of packets to be sent to the network in the sending being restricted in accordance with a band that is usable for the network, and, after the sending timing associated with the packet, a packet that is not sent at the sending timing being sent in the sending.

A packet control apparatus according to an example aspect of the present invention includes: an acquisition section that acquires a packet which is associated with a sending timing; an enqueue section that enqueues the packet into any of a plurality of queues in accordance with the sending timing which is associated with the packet; and a sending section that dequeues a packet from each of the plurality of queues in accordance with a dequeue timing specified for the queue and that sends the packet to a network, the number of packets to be sent to the network by the sending section being restricted in accordance with a band that is usable for the network, and the sending section sending, after the sending timing associated with the packet, a packet that is not sent at the sending timing.

### Advantageous Effects of Invention

According to an example aspect of the present invention, a network can be strategically utilized even in a case where a band that is usable for the network varies.

### BRIEF DESCRIPTION OF DRAWINGS

FIG. 1 is a block diagram illustrating a configuration of a packet control method according to a first example embodiment.

FIG. 2 is a flowchart illustrating a flow of a packet control method according to the first example embodiment.

FIG. 3 is a block diagram illustrating a configuration of a packet control apparatus according to the first example embodiment.

FIG. 4 is a block diagram illustrating a configuration of an information processing apparatus according to a second example embodiment.

FIG. 5 is a diagram schematically illustrating an example configuration related to packet transmission control by the information processing apparatus according to the second example embodiment.

FIG. 6 is a diagram illustrating a specific example of a plurality of queues according to the second example embodiment.

FIG. 7 is a flowchart illustrating a flow of an enqueuing process according to the second example embodiment.

FIG. 8 is a diagram illustrating a specific example of the enqueuing process according to the second example embodiment.

FIG. 9 is a flowchart illustrating a flow of a dequeuing process according to the second example embodiment.

FIG. 10 is a diagram illustrating a specific example of a packet-out process according to the second example embodiment.

FIG. 11 is a diagram illustrating a specific example of a reenqueuing process according to the second example embodiment.

FIG. 12 is a diagram illustrating a specific example of a reenqueuing process according to the second example embodiment.

FIG. 13 is a diagram illustrating a specific example of a packet-out process according to the second example embodiment.

FIG. 14 is a diagram illustrating a specific example of a packet-out process according to the second example embodiment.

FIG. 15 is a diagram illustrating example results of measuring a delay time and a delay jitter according to the second example embodiment.

FIG. 16 is a diagram for explaining an example of a process for calculating a request level.

FIG. 17 is a diagram for explaining a sending timing of a packet stored in a queue.

FIG. 18 is a diagram illustrating an example of results of measuring a delay time.

FIG. 19 is a diagram illustrating an example of measurement results for the order of packets.

FIG. 20 is a flowchart illustrating another example of the enqueuing process that is carried out by an enqueue unit.

FIG. 21 is a diagram for explaining the enqueuing process that is carried out by the enqueue unit.

FIG. 22 is a diagram illustrating an example of a computer which executes instructions of a program that is software realizing functions of apparatuses according to example embodiments of the present invention.

### DESCRIPTION OF EMBODIMENTS

### First Example Embodiment

The following description will discuss a first example embodiment of the present invention in detail with reference to the drawings. The present example embodiment is a basic form of an example embodiment described later.

### <Configuration of Packet Control System>

The following description will discuss a configuration of a packet control system 1 according to the present example embodiment with reference to FIG. 1. FIG. 1 is a block diagram illustrating a configuration of the packet control system 1. The packet control system 1 includes an acquisition unit 11, an enqueue unit 12, and a sending unit 17. The acquisition unit 11, the enqueue unit 12, and the sending unit 17 are examples of an acquisition section, an enqueue section, and a sending section, respectively, in this specification.

The acquisition unit 11 acquires a packet that is associated with a sending timing. A packet that is acquired by the acquisition unit 11 is to be subjected to transmission control. A packet that is acquired by the acquisition unit 11 may be associated not only with a sending timing but also with a delay jitter that is requested, or with a throughput that is requested. Examples of the packet associated with the sending timing include a packet that is used in an application in which handling in real time is important. Examples of such a packet include, but are not limited to, packets for voice communication and the like.

As a technique for associating a packet with a delay jitter, a delay time, a throughput, and the like which are requested, for example, a tag (information bit, or the like) in which requirements are described can be given as a header or a trailer of the packet. Alternatively, for example, a delay jitter that is requested may be associated with each packet by describing requirements in an option field of a header of the packet. The requirements (delay jitter, delay time, throughput, and the like) associated with a packet vary depending on, for example, the type of application of the packet. In other words, the requirements associated with the packet correspond to the type of application.

The enqueue unit 12 enqueues a packet into one of a plurality of queues in accordance with a sending timing associated with the packet. The plurality of queues are used by the packet control system 1 for packet transmission control. For example, different timings are specified for the plurality of queues as dequeue timings. For example, the enqueue unit 12 enqueues a packet into a queue corresponding to a sending timing associated with the packet.

The sending unit 17 dequeues a packet from each of the plurality of queues in accordance with a dequeue timing specified for that queue, and sends the packet to a network. Here, the number of packets sent to the network by the sending unit 17 is restricted in accordance with a band that is usable for the network. The sending unit 17 sends, after a sending timing associated with the packet, a packet which is not sent at the sending timing. For example, in a case of a communication system such as long term evolution (LTE) in which a frequency bandwidth can be selected, a usable band varies depending on a congestion condition of the frequency band and the like. In a network in which a usable band is not constant, a delay and a delay jitter may rapidly increase severalfold due to occurrence of an instantaneous overload and the like in the usable band, and a situation may occur in which a packet cannot be sent at a sending timing associated with the packet.

For example, the sending unit 17 sends, in accordance with a priority order corresponding to an amount of delay from a sending timing associated with a packet, a packet which has not been sent at the sending timing. For example, the sending unit 17 may determine, based on the number of enqueued packets enqueued in a queue corresponding to a sending timing associated with a packet, whether or not to enqueue the packet into the queue. In this case, in a case where the sending unit 17 has determined not to enqueue the packet into the queue, the sending unit 17 enqueues the packet into a queue that is different from the queue. The packet which has been enqueued into the different queue is dequeued at a dequeue timing associated with that different queue and is sent to a network. In this specification, the term “dequeue” refers to an action of taking out a packet from a queue. Moreover, the phrase “sending of a packet” refers to an action of sending a dequeued packet to a communication link.

As described above, the packet control system 1 according to the present example embodiment employs the configuration of including: an acquisition unit 11 that acquires a packet which is associated with a sending timing; an enqueue unit 12 that enqueues the packet into any of a plurality of queues in accordance with the sending timing which is associated with the packet; and a sending unit 17 that dequeues a packet from each of the plurality of queues in accordance with a dequeue timing specified for the queue and that sends the packet to a network, the number of packets to be sent to the network by the sending unit 17 being restricted in accordance with a band that is usable for the network, and the sending unit 17 sending, after the sending timing associated with the packet, a packet that is not sent at the sending timing. Therefore, according to the packet control system 1 according: example embodiment, it is possible to bring about an effect that a network can be strategically utilized even in a case where a band that is usable for the network varies.

### <Flow of Packet Control Method>

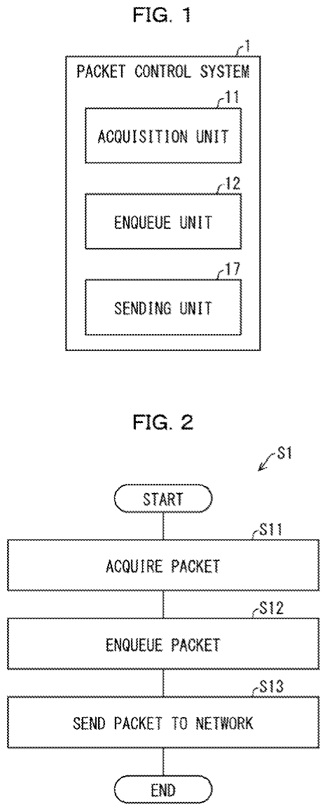

The following description will discuss a flow of a packet control method S1 according to the present example embodiment with reference to FIG. 2. FIG. 2 is a flowchart illustrating the flow of the packet control method S1. An execution subject of each step in the packet control method S1 may be a processor that is included in the packet control system 1 or may be a processor that is included in another apparatus. Alternatively, the execution subject of each step can be processors that are provided in different apparatuses.

In a step S11, at least one processor acquires a packet associated with a sending timing. In a step S12, the at least one processor enqueues the packet into any of the plurality of queues in accordance with the sending timing associated with the packet.

In a step S13, the at least one processor dequeues a packet from each of the plurality of queues in accordance with a dequeue timing specified for that queue, and sends the packet to a network. Here, the number of packets to be sent to the network in the step S13 is restricted in accordance with a band that is usable for the network. Moreover, in the step S13, after a sending timing associated with the packet, a packet which is not sent at the sending timing is sent.

As described above, the packet control method S1 according to the present example embodiment employs the configuration of including: acquiring a packet which is associated with a sending timing; enqueuing the packet into any of a plurality of queues in accordance with the sending timing which is associated with the packet; and dequeuing a packet from each of the plurality of queues in accordance with a dequeue timing specified for the queue and sending the packet to a network, the number of packets to be sent to the network in the sending being restricted in accordance with a band that is usable for the network, and, after the sending timing associated with the packet, a packet that is not sent at the sending timing being sent in the sending. Therefore, according to the packet control method S1 according to the present example embodiment, it is possible to bring about an effect that a network can be strategically utilized even in a case where a band that is usable for the network varies.

### <Configuration of Packet Control Apparatus>

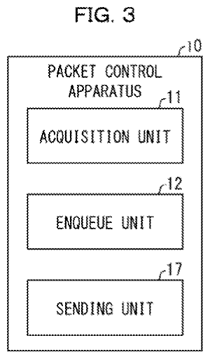

The following description will discuss a configuration of a packet control apparatus 10 according to the present example embodiment with reference to FIG. 3. FIG. 3 is a block diagram illustrating a configuration of the packet control apparatus 10. The packet control apparatus 10 includes an acquisition unit 11, an enqueue unit 12, and a sending unit 17. The acquisition unit 11, the enqueue unit 12, and the sending unit 17 have the same functions as the acquisition unit 11, the enqueue unit 12, and the sending unit 17 included in the packet control system 1 described above.

As described above, the packet control apparatus 10 according to the present example embodiment employs the configuration of including: an acquisition unit 11 that acquires a packet which is associated with a sending timing; an enqueue unit that enqueues the packet into any of a plurality of queues in accordance with the sending timing which is associated with the packet; and a sending unit 17 that dequeues a packet from each of the plurality of queues in accordance with a dequeue timing specified for the queue and that sends the packet to a network, the number of packets to be sent to the network by the sending unit 17 being restricted in accordance with a band that is usable for the network, and the sending unit 17 sending, after the sending timing associated with the packet, a packet that is not sent at the sending timing. Therefore, according to the packet control apparatus 10 according to the present example embodiment, it is possible to bring about an effect that a network can be strategically utilized even in a case where a band that is usable for the network varies.

### Second Example Embodiment

The following description will discuss a second example embodiment of the present invention in detail with reference to the drawings. The same reference numerals are given to constituent elements which have functions identical with those described in the first example embodiment, and descriptions as to such constituent elements are not repeated.

### <Configuration of Information Processing Apparatus>

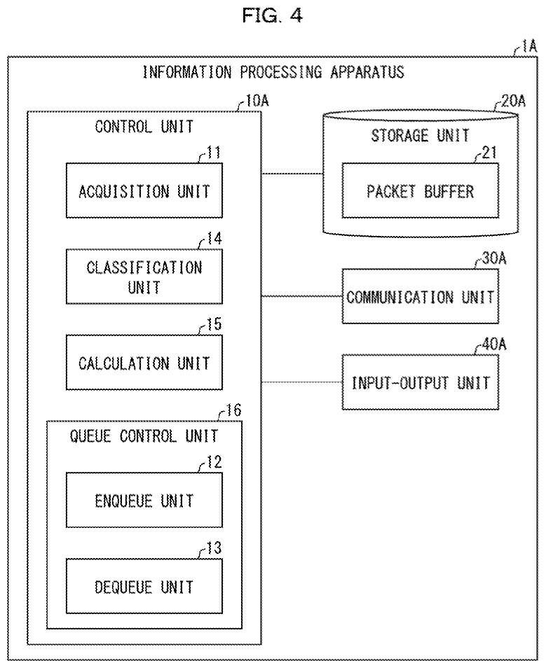

FIG. 4 is a block diagram illustrating a configuration of an information processing apparatus 1A. The information processing apparatus 1A is an apparatus that controls transmission of a packet, and is, for example, a relay apparatus. The information processing apparatus 1A is an example of the packet control apparatus according to this specification. The information processing apparatus 1A carries out network slicing by soft slicing in which communication link resource allocation is carried out in accordance with a request of an application. That is, the information processing apparatus 1A carries out packet transmission control by queuing using a plurality of queues. As illustrated in FIG. 4, the information processing apparatus 1A includes a control unit 10A, a storage unit 20A, a communication unit 30A, and an input-output unit 40A.

One or some of the functional units of the information processing apparatus 1A may be mounted on an apparatus different from the information processing apparatus 1A. For example, it is possible that a calculation unit 15 is mounted on another apparatus that is different from the information processing apparatus 1A, the information processing apparatus 1A receives a calculation result of the calculation unit 15 from the another apparatus, and a queue control unit 16 is operated. The another apparatus may be disposed in a cloud.

### (Communication Unit 30A)

The communication unit 30A communicates with an apparatus outside of the information processing apparatus 1A via a communication line. A specific configuration of the communication line does not limit the present example embodiment, and the communication line is, for example, a wireless local area network (LAN), a wired LAN, a wide area network (WAN), a public network, a mobile data communication network, Wi-Fi (registered trademark), long term evolution (LTE), 5G, local 5G, 4G, 3G, or a combination of these. The communication unit 30A transmits data supplied from the control unit 10A to another apparatus and supplies data received from another apparatus to the control unit 10A.

### (Input-Output Unit 40A)

Input-output apparatuses such as a keyboard, a mouse, a display, a printer, and a touch panel are connected to the input-output unit 40A. The input-output unit 40A receives input of various kinds of information with respect to the information processing apparatus 1A from a connected input apparatus. The input-output unit 40A outputs various kinds of information to a connected output apparatus under control by the control unit 10A. Examples of the input-output unit 40A include interfaces such as universal serial bus (USB).

### (Control Unit 10A)

As illustrated in FIG. 4, the control unit 10A includes an acquisition unit 11, a classification unit 14, a calculation unit 15, and a queue control unit 16.

### (Acquisition Unit 11)

The acquisition unit 11 acquires a packet that is to be subjected to transmission control. For example, at least one of an arrival time of a packet, a delay time that is requested, a throughput that is requested, and a delay jitter that is requested is associated with the packet which is to be subjected to transmission control. From the delay time that is requested and the arrival time of the packet, a sending timing that is requested is specified. Therefore, it can be said that the packet which is associated with the arrival time of the packet and the delay time that is requested is a packet which is associated with the sending timing that is requested. In other words, the acquisition unit 11 acquires the packet that is associated with the sending timing that is requested and with the delay jitter. The acquisition unit 11 acquires a packet that is associated with the delay jitter and a packet that is not associated with the delay jitter. In other words, the acquisition unit 11 acquires a packet that is associated with a throughput which is requested.

### (Classification Unit 14)

The classification unit 14 carries out classification of packets. For example, the classification unit 14 carries out classification on the basis of the type of application of a packet or the like, and outputs a flow ID indicating a result of the classification. The term “classification” refers to, for example, an action of classifying packets in accordance with which one of a throughput, a delay, and a delay jitter is requested. For example, a packet for which a throughput is requested is a packet of a moving image, and a packet for which a delay is requested is a packet of urgent communication. A packet for which a delay jitter is requested is, for example, a packet of real time sensing or of remote control.

### (Calculation Unit 15)

The calculation unit 15 calculates a packet-out requirement, which is a requirement for packet-out. The packet-out requirement is various conditions demanded in packet-out of a packet. The packet-out requirement includes, for example, a request time and a request level. The request time is a time of packet-out which is requested. The request time is an example of a sending timing according to this specification. The request level is a level of a queue for which packet-out is requested. The request level is an example of the first level according to this specification. A method for calculating a packet-out requirement that is carried out by the calculation unit 15 will be described later.

### (Queue Control Unit 16)

The queue control unit 16 carries out packet transmission control by queuing using a plurality of queues. The queue control unit 16 carries out packet transmission control using, for example, a calendar queuing technique. The queue control unit 16 includes an enqueue unit 12 and a dequeue unit 13. The enqueue unit 12 enqueues a packet into one of a plurality of queues which are classified into levels. The enqueue unit 12 reenqueues a packet which has been dequeued from a queue at a second level into a queue at a first level that corresponds to the delay jitter associated with the packet, the second level being different from the first level.

In the present example embodiment, the plurality of levels correspond to different delay jitters. In other words, the level is a classification that is assigned in accordance with a range of delay jitter values. More specifically, for example, delay granularity is greater as the level increases, and delay granularity is smaller as the level decreases. Therefore, it is also possible to say that the plurality of queues are classified into a plurality of levels in accordance with delay granularity.

The dequeue unit 13 dequeues a packet from each of a plurality of queues in accordance with a dequeue timing specified for each queue. The dequeue unit 13 sends a packet which has been dequeued from a request level to a network. The dequeue unit 13 is an example of the sending section in this specification.

### (Storage Unit 20A)

The storage unit 20A includes a packet buffer 21. The packet buffer 21 is a memory space that is secured for storing packets waiting for transmission. Packets which have been buffered in the packet buffer 21 are sent to a network after delay times and the like thereof are controlled by the plurality of queues.

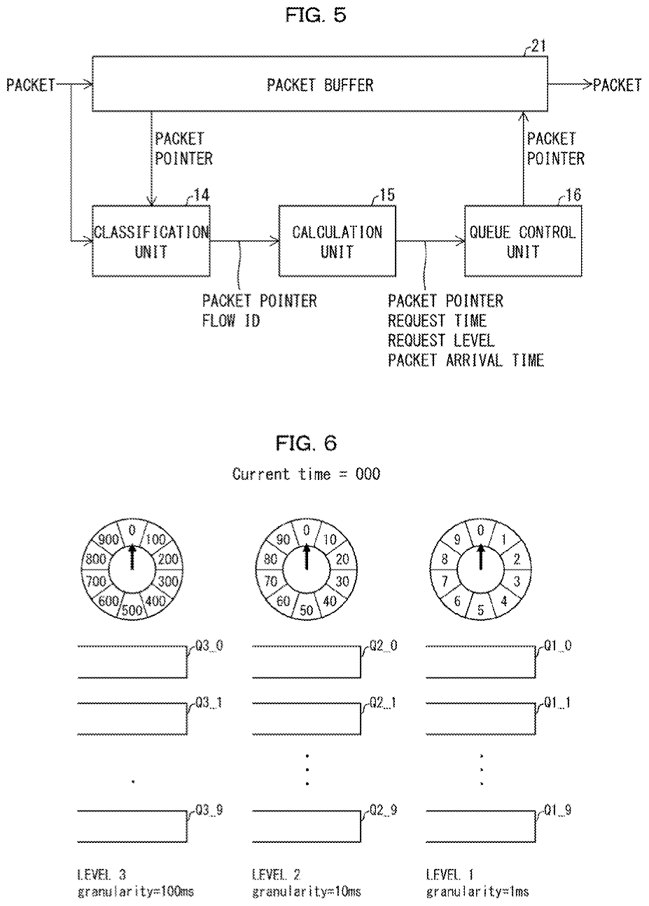

FIG. 5 is a diagram schematically illustrating an example configuration related to packet transmission control by the information processing apparatus 1A. Note that, in FIG. 5, the unidirectional arrow simply indicates the direction of flow of a certain signal (data), and is not intended to eliminate bidirectionality. In the example illustrated in FIG. 5, the classification unit 14 carries out packet classification and supplies a flow ID indicating the classification result to the calculation unit 15 together with a packet pointer that has been acquired from the packet buffer 21. The classification by the classification unit 14 is carried out on the basis of, for example, the type of application. The flow ID indicating the classification result is referred to when the calculation unit 15 calculates a packet-out requirement. The calculation unit 15 calculates a packet-out requirement by a calculation technique corresponding to the flow ID. In other words, the calculation unit 15 specifies a packet-out requirement in accordance with the type of application. The calculation unit 15 can also be said to change a numerical value or a weight that is used to calculate a packet-out requirement, in accordance with the type of application. In other words, the calculation unit calculates the sending timing of the packet by a calculation technique that corresponds to the application type of the packet acquired by the acquisition unit 11. Note that the flow ID indicating the classification result is not referred to in queue control by the queue control unit 16. The packet pointer is a pointer which indicates a storage location of each packet in the packet buffer 21.

The calculation unit 15 calculates a packet-out requirement by a calculation technique corresponding to the flow ID. In the present example embodiment, the calculation unit 15 calculates a request time and a request level as packet-out requirements. The calculation unit 15 supplies the calculated packet-out requirements to the queue control unit 16 together with a packet pointer and a packet arrival time. The queue control unit 16 carries out packet transmission control using a plurality of queues. The queue control unit 16 carries out transmission control by queuing with use of the plurality of queues and sends packets to a network.

The following description will discuss a specific example of a plurality of queues that are used by the queue control unit 16 for packet transmission control, with reference to the drawings. FIG. 6 is a diagram illustrating a specific example of a plurality of queues. In the example illustrated in FIG. 6, the queue control unit 16 carries out packet transmission control by calendar queuing with use of (i×j) queues Qi_j (1≤i≤3, 0≤j≤9). The plurality of queues Qi_j are classified into a plurality of levels i. That is, ten queues Qi_0 through Qi_9 are prepared for each level i. In the example illustrated in FIG. 6, a level 3 is the highest level and a level 1 is the lowest level. Further, in the example illustrated in FIG. 6, a virtual time unit is set to 1 [ms].

The plurality of queues vary in delay granularity for each level. In other words, the plurality of queues are classified into levels such that delay granularity is greater as the level increases. In the example of FIG. 6, the delay granularity of the queues Q1_j at the level 1 is 1 [ms]. The delay granularity of the queues Q2_j at the level 2 is 10 [ms]. The delay granularity of the queues Q3_j at the level 3 is 100 [ms].

The enqueue unit 12 enqueues a packet which is to be subjected to transmission control into a queue corresponding to a request time associated with the packet. The dequeue unit 13 dequeues, in accordance with a dequeue timing specified for the queue, the packet which has been enqueued into the queue. Details of the enqueuing process and the dequeuing process will be described later.

### <Flow of Packet Control Method>

The information processing apparatus 1A carries out packet transmission control with use of a plurality of queues. In the following description, (i) a packet enqueuing process and (ii) a packet dequeuing process will be described in order.

### ((i) Packet Enqueuing Process)

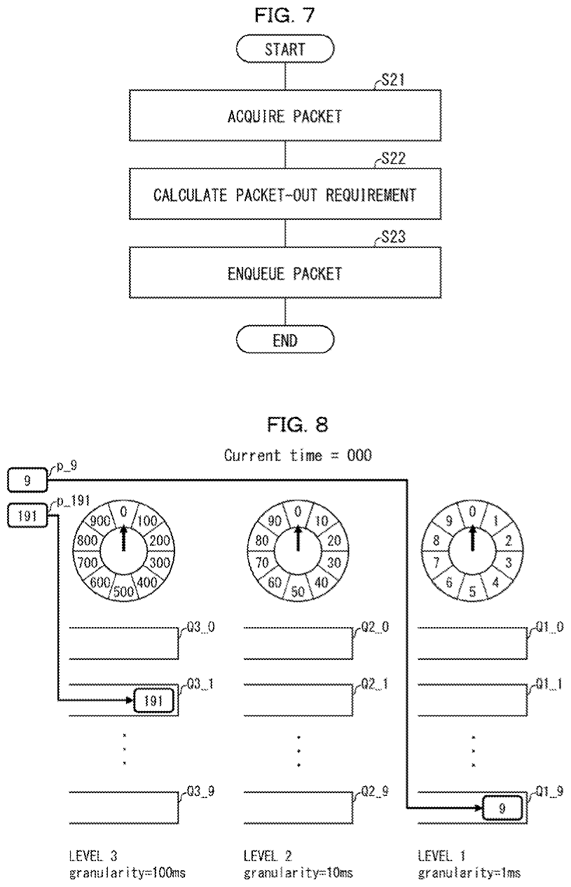

FIG. 7 is a flowchart illustrating a flow of a packet enqueuing process.

### (Steps S21 and S22)

In a step S21, the acquisition unit 11 acquires a packet which is to be subjected to transmission control. Moreover, in a step S22, the calculation unit 15 calculates a packet-out requirement for the packet acquired in the step S21. The calculation unit 15 calculates a packet-out requirement by a calculation technique that corresponds to the type of request flow. The following description will discuss specific examples of methods for calculating a packet-out requirement for cases of a throughput request flow (a), a delay request flow (b), and a delay jitter request flow (c).

### (Throughput Request Flow (a))

The throughput request flow (a) is a flow in which a throughput is requested. In a case where a transmission time of one previous packet is defined as “uₜ₋₁ [s]”, a packet size is defined as “s [byte]”, and a request throughput is “x [bps]”, a request time u at which packet-out is requested is, for example, u=uₜ₋₁+8s/x.

In the case of the throughput request flow, a delay jitter is not requested and it is not necessary to control the delay jitter. Therefore, a request level 1 is an arbitrary level. Therefore, for example, the calculation unit 15 sets the request level 1 to be the highest level of a plurality of queues. In other words, the calculation unit 15 calculates the highest level among a plurality of levels as the request level 1 for a packet that is not associated with a delay jitter. For example, in a case where levels 1 to 3 are set as levels for queues, the calculation unit 15 determines the level 3 as the request level 1. Note that the method for calculating the request time u and the request level 1 is not limited to the example described above, and the calculation unit 15 may calculate the request time u or the request level 1 by another method. For example, the calculation unit 15 may calculate, as the request level 1 for a packet associated with a throughput, a level that is one level below a level corresponding to calculation granularity of the throughput.

### (Delay Request Flow (b))

The delay request flow is a flow in which a delay is requested. In a case where the current time is defined as “t [s]” and a delay time that is requested is defined as “y [s]”, the request time u is, for example, represented as follows: u=t+y.

In the case of the delay request flow, a delay jitter is not requested and it is not necessary to control the delay jitter. Therefore, the request level 1 is an arbitrary level. Therefore, for example, the calculation unit 15 sets the request level 1 to be the highest level of a plurality of queues. In other words, the calculation unit 15 calculates the highest level among a plurality of levels as the request level 1 for a packet that is not associated with a delay jitter. For example, in a case where levels 1 to 3 are set as levels for queues, the calculation unit 15 determines the level 3 as the request level 1.

Note that the method for calculating the request time u and the request level 1 is not limited to the example described above, and the calculation unit 15 may calculate the request time u or the request level 1 by another method. For example, the calculation unit 15 may calculate, as the request level 1 for a packet associated with a throughput, a level that is one level below a level corresponding to calculation granularity of the throughput.

### (Delay Jitter Request Flow (c))

The delay jitter request flow is a flow in which a delay jitter is requested. In this case, a transmission time of one previous packet is defined as “uₜ₋₁ [s]”, a delay time that is requested is defined as “y [s]”, and a delay jitter that is requested is defined as “z [s]”. Furthermore, granularity of the level i of a queue is defined as “gᵢ” and a virtual time unit is defined as “v”. Then, the request time u is, for example, represented as follows: u=uₜ₋₁+y. The request level 1 is, for example, represented as follows: 1=argmaxᵢ (gᵢv<z). In other words, the calculation unit 15 calculates a request level (first level) with use of a delay jitter associated with a packet.

### (Step S23)

In a step S23 of FIG. 7, the enqueue unit 12 enqueues the packet acquired in the step S21 into one of the plurality of queues. More specifically, the enqueue unit 12 enqueues the packet into a queue corresponding to the request time u which has been calculated by the calculation unit 15. In other words, the enqueue unit 12 enqueues the packet acquired by the acquisition unit 11 into a queue corresponding to the request time u which is associated with the packet.

In the example illustrated in FIG. 6, the enqueue unit 12 refers to the last three digits of the request time u, and enqueues packets whose last three digits are between 000 and 00j [ms] (0≤j≤9) into queues Q1_j at the level 1. Moreover, the enqueue unit 12 enqueues packets whose last three digits are between 010 and 099 [ms] into queues Q2_j at the level 2. More specifically, the enqueue unit 12 enqueues packets for which values of the second digit from the last of the request time u are j (0≤j≤9) into the queues Q2_j at the level 2. The enqueue unit 12 enqueues packets whose last three digits are between 100 and 999 [ms] into queues Q3_j at the level 3. More specifically, the enqueue unit 12 enqueues packets for which values of the third digit from the last of the request time u are j (0≤j≤9) into the queues Q3_j at the level 3.

More specifically, for example, the enqueue unit 12 enqueues a packet for which the request time u is 50 [ms] to 59 [ms] into a queue Q2_5 at the level 2. Moreover, for example, the enqueue unit 12 enqueues a packet for which the request time u is 60 [ms] to 69 [ms] into a queue Q2_6 at the level 2. Furthermore, for example, the enqueue unit 12 enqueues a packet for which the request time is 100 [ms] to 199 [ms] into a queue Q3_1 at the level 3.

### (Specific Example of Enqueuing)

FIG. 8 is a diagram illustrating a specific example of the enqueuing process. In the example illustrated in FIG. 8, the enqueue unit 12 enqueues a packet p_9, for which the request time u calculated by the calculation unit 15 is “9”, into a queue Q1_9 at the level 1. Moreover, the enqueue unit 12 enqueues a packet p_191, for which the request time u calculated by the calculation unit 15 is “191”, into a queue Q3_1 at the level 3.

((ii) Packet Dequeuing Process)

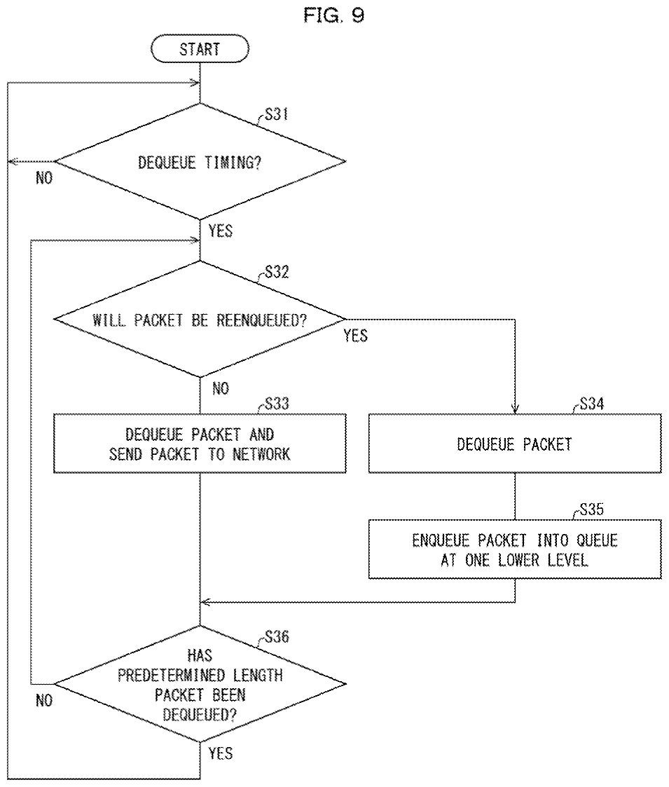

FIG. 9 is an example flowchart illustrating a flow of a dequeuing process that is carried out by the information processing apparatus 1A. In this example, the dequeue unit 13 carries out the process illustrated in FIG. 9 for each of the (i×j) queues Qi_j. Note, however, that the flow of the dequeuing process that is carried out by the dequeue unit 13 is not limited to the example illustrated in FIG. 9.

### (Step S31)

In a step S31, the dequeue unit 13 determines whether or not it is a dequeue timing specified for a queue Qi_j that is to be processed. In a case where it is the dequeue timing (YES in the step S31), the dequeue unit 13 proceeds to a process of a step S32. Meanwhile, in a case where it is not the dequeue timing (NO in the step S31), the dequeue unit 13 waits until the dequeue timing comes.

Here, the dequeue timing specified for each of n queues Qi_j at the level i is, for example, times (j·nⁱ⁻¹), (j·nⁱ⁻¹+1), (j·nⁱ⁻¹+2), . . . , and ((j+1)·nⁱ⁻¹)−1). In this case, the dequeue timing specified for the queue Q3_1 is 100, 101, 102, . . . , and 199 [ms]. Moreover, for example, the dequeue timing specified for the queue Q1_9 is 9 [ms].

### (Step S32)

In a step S32, the dequeue unit 13 determines whether or not to carry out reenqueuing. Specifically, for example, the dequeue unit 13 determines whether or not the request level 1 of a packet (a packet at the beginning of a queue) which is to be dequeued is higher than the level i of a queue Qi_j which is to be processed, and thus determines whether or not to carry out reenqueuing. In a case where the request level 1 is equal to or higher than the level i of the queue Qi_j to be processed, the dequeue unit 13 determines not to carry out reenqueuing. Meanwhile, in a case where the request level 1 is lower than the level i, the dequeue unit determines to carry out reenqueuing. In the case where reenqueuing is not carried out (NO in the step S32), the dequeue unit 13 proceeds to a process of a step S33. Meanwhile, in the case where reenqueuing is carried out (YES in the step S32), the dequeue unit 13 proceeds to a process of a step S34.

Note, however, that the method for carrying out the determination process in the step S32 is not limited to the example described above, and the dequeue unit 13 may determine whether or not to carry out reenqueuing by another method. For example, the dequeue unit 13 may determine whether or not to carry out reenqueuing according to whether or not a value of a delay jitter that is requested satisfies a predetermined condition. More specifically, for example, it is possible that the dequeue unit 13 carries out reenqueuing in a case where the value of the delay jitter that is requested is equal to or less than a threshold value, and determines to carry out packet-out without carrying out reenqueuing in a case where the value of the delay jitter that is requested is equal to or greater than the threshold value.

### (Step S33)

In a step S33, the dequeue unit 13 dequeues a packet and sends the packet to a network.

### (Steps S34 and S35)

In a step S34, the dequeue unit 13 dequeues a packet from the queue Qi_j. In a step S35, the enqueue unit 12 enqueues the packet which has been dequeued by the dequeue unit 13 in the step S34 into a queue at a level that is one level below, that is, a queue Q(i-1)_j at the level (i-1). In other words, the enqueue unit 12 enqueues a packet which has been dequeued from a queue at the second level into a queue at a level that is one level below the second level, the second level being higher than the request level (first level).

By repeating the processes of the steps S32 through S36 in FIG. 9, the process is repeated in which a packet which has been enqueued into a queue is reenqueued into a queue at a level that is one level below that of said queue, and the packet which has been reenqueued is further reenqueued into a queue at a level that is another one level below.

### (Step S36)

In a step S36, the dequeue unit 13 determines whether or not a packet included in a predetermined length of the queue Qi_j that is subjected to determination has been dequeued. The predetermined length is, for example, a queue length (1/nⁱ⁻¹). Here, “i” is the level and “n” is the number of queues at each level. In a case where a packet included in a predetermined length has been dequeued (YES in the step S36), the dequeue unit 13 returns to the process in the step S31 and waits until the next dequeue timing comes. Meanwhile, in a case where a packet included in a predetermined length has not been dequeued (NO in the step S36), the dequeue unit 13 returns to the process of the step S32 and carries out a dequeuing process for the next packet.

That is, in this example, the dequeue unit 13 dequeues, at a dequeue timing specified for a queue Qi_j, a part of packets (i.e., a packet(s) included in a queue length of (1/nⁱ)) instead of dequeuing all the packets which have been enqueued into the queue Qi_j. By repeating the process of dequeuing a part of packets every time a dequeue timing comes, all packets which have been enqueued into n queues Qi_j at the level i are dequeued when a time nⁱ has elapsed.

For example, packets are discharged from the queue Q2_5 in units of 1/10 during a period between 50 [ms] and 59 [ms]. That is, a packet of 50 [ms] to 59 [ms] is discharged at an arbitrary timing during a period between 50 [ms] and 59 [ms].

Packets are discharged from the queue Q2_6 in units of 1/10 during a period between 60 [ms] and 69 [ms]. That is, a packet of 60 [ms] to 69 [ms] is discharged at an arbitrary timing during a period between 60 [ms] and 69 [ms].

Packets are discharged from the queue Q3_1 in units of 1/100 during a period between 100 [ms] and 199 [ms]. That is, a packet for which the request time is 100 [ms] to 199 [ms] is discharged at an arbitrary timing during a period between 100 [ms] and 199 [ms].

Similarly, packets are discharged from the queue Q3_2 in units of 1/100 during a period between 200 [ms] and 299 [ms]. That is, a packet for which the request time is 200 [ms] to 299 [ms] is discharged at an arbitrary timing during a period between 200 [ms] and 299 [ms].

As described above, by repeatedly carrying out the processes of the steps S31 through S36, the dequeue unit 13 dequeues, in one or more separate stages, packets which have been enqueued into each queue (steps S33 and S34).

As described above, in the example illustrated in FIG. 9, the dequeue unit 13 determines, at a dequeue timing specified for each queue, whether or not to reenqueue a packet to be dequeued (step S32 in FIG. 9). In a case where reenqueuing is carried out, the dequeue unit 13 reenqueues the packet into a queue at a level different from that of the queue (steps S34 and S35). Meanwhile, in a case where reenqueuing is not carried out, the dequeue unit 13 sends the packet which has been dequeued to a network (step S33).

### (Specific Examples of Packet-Out Process and Reenqueuing Process)

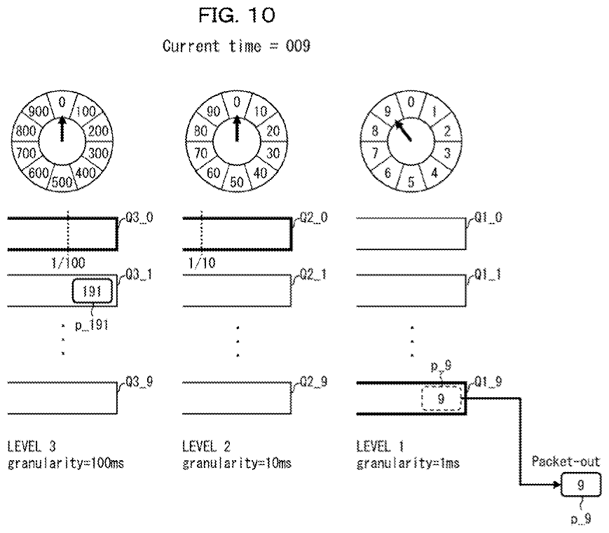

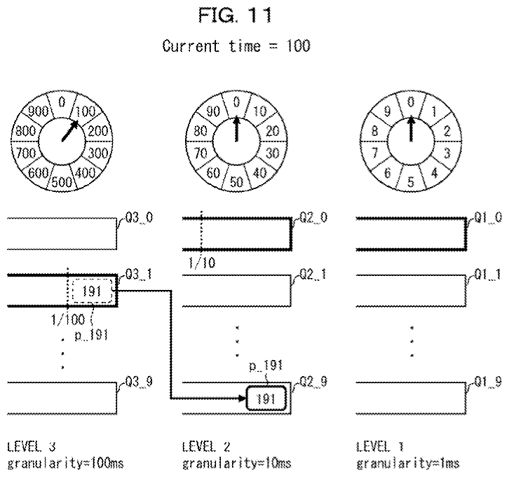

Specific examples of the packet-out process and the reenqueuing process will be described with reference to FIGS. 10 through 14. FIG. 10 is a diagram illustrating a specific example of the packet-out process. In the example illustrated in FIG. 10, at a time t=009, the dequeue unit 13 takes out the packet p_9 (packet-out) stored in the queue Q1_9 and thus sends the packet p_9 to a network (step S33 in FIG. 9).

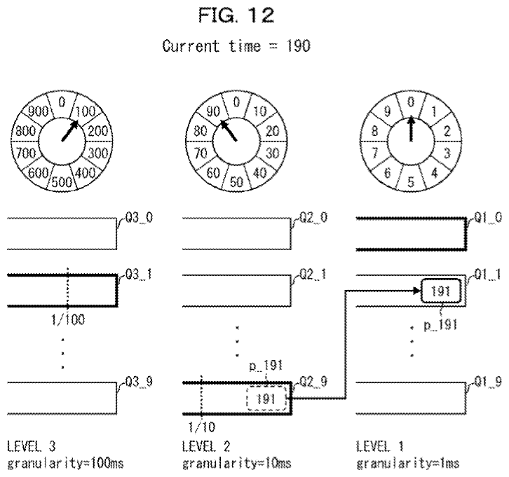

FIGS. 11 and 12 are diagrams illustrating specific examples of the reenqueuing process. In the example illustrated in FIG. 11, at a time t=100, three queues, i.e., the queue Q3_1, the queue Q2_0, and the queue Q1_0 are to be subjected to dequeuing. Here, in a case where the request level 1 of the packet p_191 stored in the queue Q3_1 is “1”, the level “3” of the queue Q3_1 is higher than the request level 1 (“1”). Therefore, the dequeue unit 13 reenqueues the packet p_191 which has been dequeued from the queue Q3_1 into the queue Q2_9 at the level 2 instead of merely taking out the packet p_191 (packet-out) (step S35 in FIG. 9).

In the example illustrated in FIG. 12, at a time t=190, three queues, i.e., the queue Q3_1, the queue Q2_9, and the queue Q1_0 are to be subjected to dequeuing. In a case where the request level 1 of the packet p_191 stored in the queue Q2_9 is “1”, the level “2” of the queue Q2_9 is higher than the request level 1 (“1”). Therefore, the dequeue unit 13 reenqueues the packet p_191 which has been dequeued from the queue Q2_9 into the queue Q1_1 at the level 1 instead of merely taking out the packet p_191 (packet-out) (step S35 in FIG. 9).

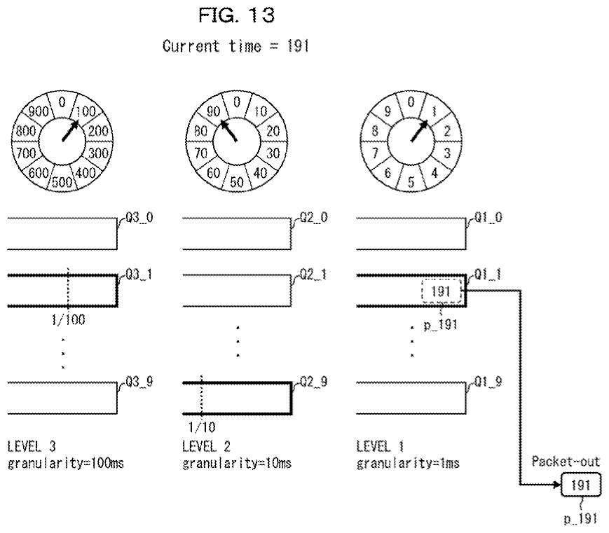

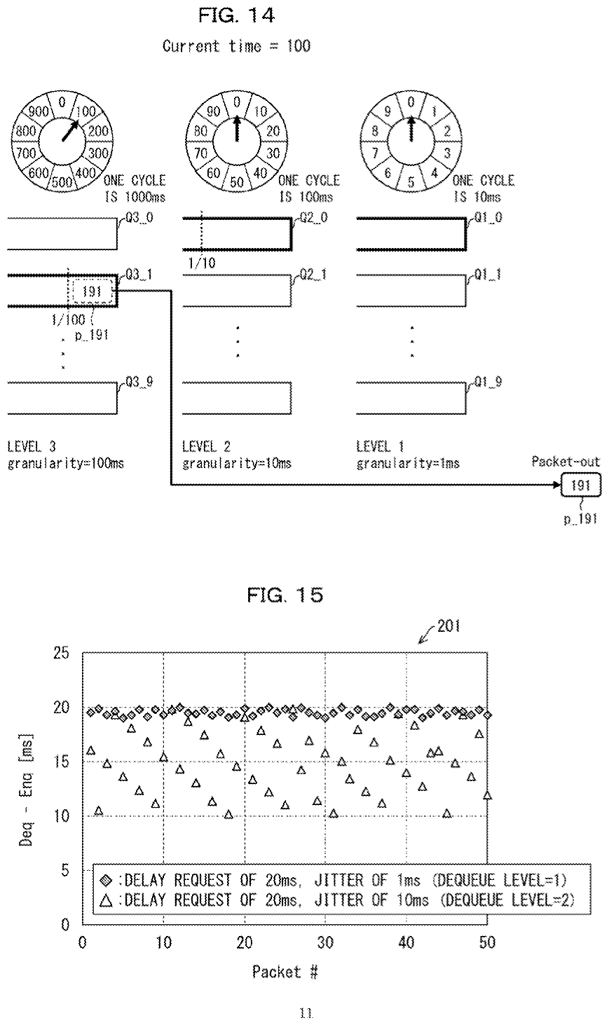

FIGS. 13 and 14 are diagrams illustrating specific examples of the packet-out process. At a time t=191, three queues, i.e., the queue Q3_1, the queue Q2_9, and the queue Q1_1 are to be determined as to whether or not dequeuing is carried out. In a case where the request level 1 of the packet p_191 stored in the queue Q1_1 is “1”, the dequeue unit 13 dequeues the packet p_191 from the queue Q1_1 and carries out packet-out (step S33 in FIG. 9).

FIG. 14 is a diagram illustrating another specific example of packet-out. At a time t=100, three queues, i.e., the queue Q3_1, the queue Q2_0, and the queue Q1_0 are to be determined as to whether or not dequeuing is carried out. In a case where the request level 1 of the packet p_191 stored in the queue Q3_1 is “3” (“YES” in step S32 of FIG. 9), the dequeue unit 13 dequeues the packet p_191 from the queue Q1_1 and carries out packet-out (step S33 in FIG. 9).

FIG. 15 is a diagram illustrating an example of results of measuring a delay time and a delay jitter. In FIG. 15, a graph 201 is a graph showing a result of packet transmission control carried out by the information processing apparatus 1A according to the present example embodiment. As illustrated in FIG. 15, according to the packet transmission control according to the present example embodiment, a delay time of a packet for which a delay time that is requested is 20 [ms] falls within 20 [ms] or less. Moreover, a packet for which a delay jitter that is requested is 1 [ms] has a delay jitter of 1 [ms], and a packet for which a delay jitter that is requested is 10 [ms] has a delay jitter of 10 [ms]. As illustrated in FIG. 15, according to the present example embodiment, both a delay time that is requested and a delay jitter that is requested can be satisfied.

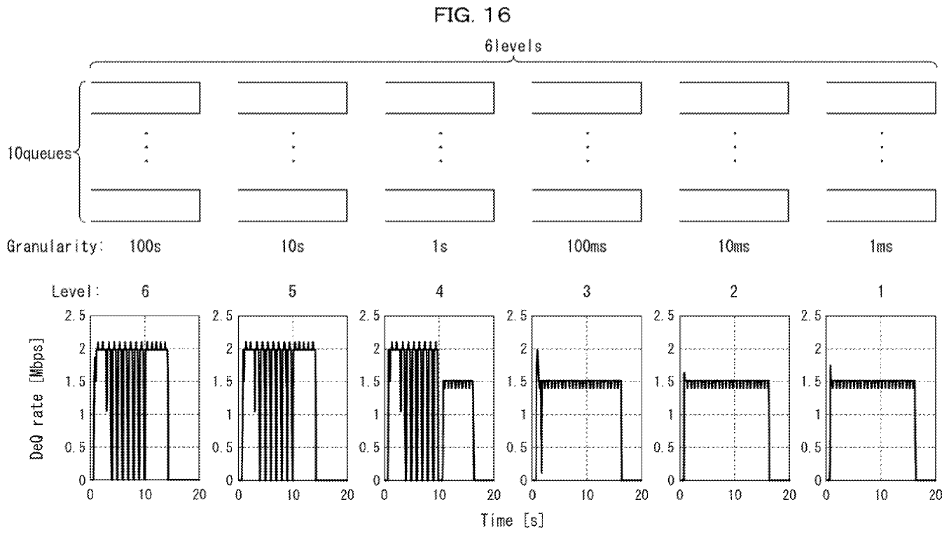

Next, an example of a process for calculating a request level for a packet that is not associated with a delay jitter will be described with reference to the drawings. FIG. 16 is a diagram for explaining an example of a request level calculation process, and shows an example of a dequeue rate [Mbps] when a request level for a packet that is not associated with a delay jitter is changed. In the example illustrated in FIG. 16, a plurality of queues are prepared at each of six levels 1 through 6 that differ in delay granularity, and a result of packet transmission control using these queues is indicated. In the example illustrated in FIG. 16, the levels 1 through 6 have delay granularity of 100 [s], 10 [s], 1 [s], 100 [ms], 10 [ms], and 1 [ms], respectively. Moreover, measurement results with a throughput bin of 100 [ms] are also indicated. As illustrated in FIG. 16, the dequeue rate is stable when the request level is 2 or less. Thus, in order to stabilize the dequeue rate, it is only necessary to set, as the request level, a level with granularity which is one stage finer than a bin size (window width) used in throughput calculation. In other words, it is only necessary to set a level that is one level below demanded throughput calculation granularity, as in examples in which granularity is 10 [ms] (i.e., level 2) when the throughput bin is 100 [ms], and granularity is 100 [ms] (level 3) when the throughput bin is 1 [s].

### <Specific Example of Packet-Out Process>

Next, a specific example of the packet-out process in the step S33 of FIG. 9 will be described. In this example, the dequeue unit 13 sends, in accordance with a priority order corresponding to an amount of delay from the sending timing (request time u) associated with the packet, a packet which has not been sent at the sending timing.

In a case where a usable band varies, a delay and a delay jitter may rapidly increase severalfold due to occurrence of an instantaneous overload. For example, in calendar queuing, a packet that is not subjected to packet-out by the request time u may occur when dequeuing is not carried out due to influence of change in the usable band. In such a case, a packet retention time in the buffer increases, and a delay and a delay jitter of the packet increase.

Specifically, for example, in a case where a packet that cannot be dequeued at the level 1 occurs due to change in the band, a delay occurs by at least a time interval (granularity at the level 1×unit time) of a dequeue timing specified for a queue. Thus, with respect to the flow at each level, a delay of N times the delay time that is requested occurs.

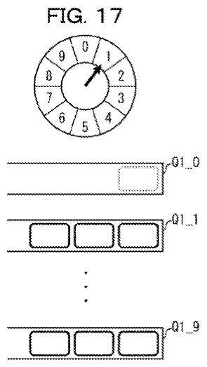

FIG. 17 is a diagram for explaining a sending timing of a packet stored in a queue. For example, in FIG. 17, in a case where a packet stored in the queue Q1_0 cannot be sent at a dequeue timing of the queue Q1_0, the packet which has not been sent is caused to wait until a next dequeue timing of the queue Q1_0 comes. Therefore, a delay of the packet which has not been sent increases by 10 [ms].

In order to deal with such a situation, in the present process example, the dequeue unit 13 sets a priority order for packets which have not been sent, and carries out packet-out in accordance with the priority order. The priority order is set in accordance with, for example, a length of time that has elapsed from a scheduled time. For example, the dequeue unit 13 sets a priority order of packets such that the priority is higher as excess time increases. Note, however, that a method for setting the priority order is not limited to the example described above, and the dequeue unit 13 may set, by another method, the priority order of packets which have not been sent.

For example, in the example illustrated in FIG. 17, the dequeue unit 13 dequeues, at the dequeue timing specified for the queue Q1_1, a packet (a packet stored in the queue 1_0) which is stored in another queue at a level identical with that of the queue Q1_1 and which is past a scheduled dequeue time, in priority over a packet stored in the queue Q1_1.

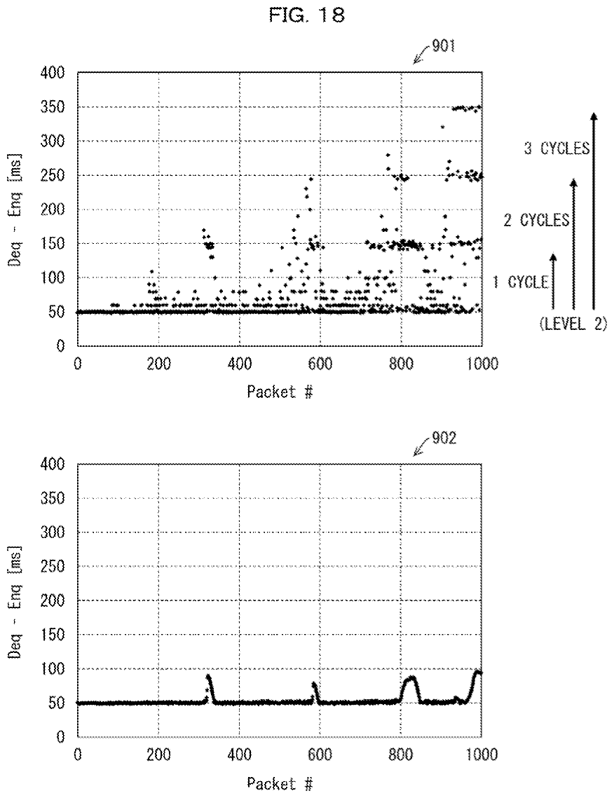

FIG. 18 is a diagram illustrating an example of results of measuring a delay time according to the present process example. In FIG. 18, a graph 901 shows results of measuring a delay time in a case where a usable band varies and packet transmission control is carried out by a conventional technique. Meanwhile, a graph 902 shows results of measuring a delay time in a case where a usable band varies and packet transmission control according to the present process example is carried out. As illustrated in FIG. 18, in the graph 901, a delay of N times a time interval of dequeue timings specified for a queue occurs, and therefore a delay jitter is greatly increased. In contrast, in the present process example, an increase in delay time is suppressed by preferentially dequeuing a packet which is stored in a queue at the same level and which is past the scheduled dequeue time.

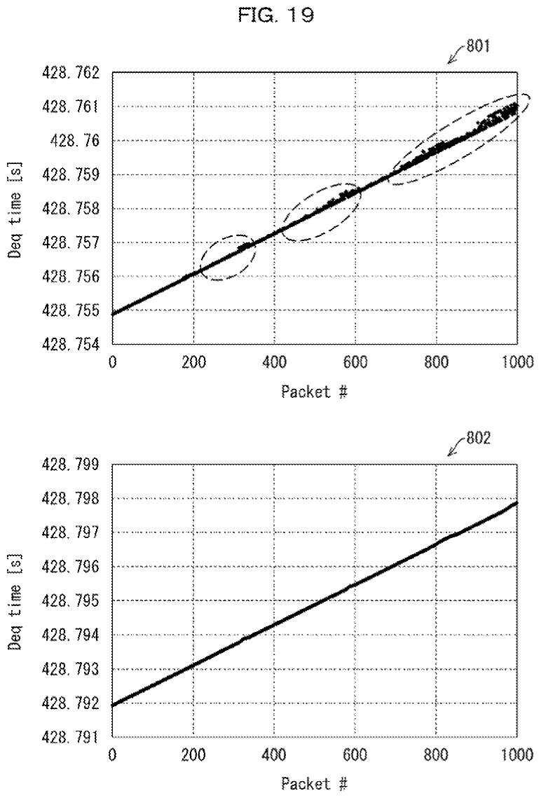

FIG. 19 is a diagram illustrating an example of measurement results for the order of packets. In FIG. 19, a graph 801 shows a relationship between a reception order and a sending order of packets in a case where a usable band varies and packet transmission control is carried out by a conventional technique. A graph 802 illustrates a relationship between a reception order and a sending order of packets in a case where a usable band varies and packet transmission control according to the present process example is carried out. As illustrated in FIG. 19, in the graph 801, an overload leads to a case where dequeuing of a packet is postponed, and therefore a change in the order occurs. In contrast, in the present process example, a packet that is past a scheduled dequeue time is preferentially dequeued, and thus occurrence of a change in the order can be prevented.

### <Another Example of Enqueuing Process>

Next, another example of the enqueuing process in the step S23 of FIG. 7 will be described. The enqueuing process that is carried out by the enqueue unit 12 is not limited to the example (i.e., the process in the step S23 in FIG. 7) described above, and the enqueue unit 12 may carry out a packet enqueuing process by another method.

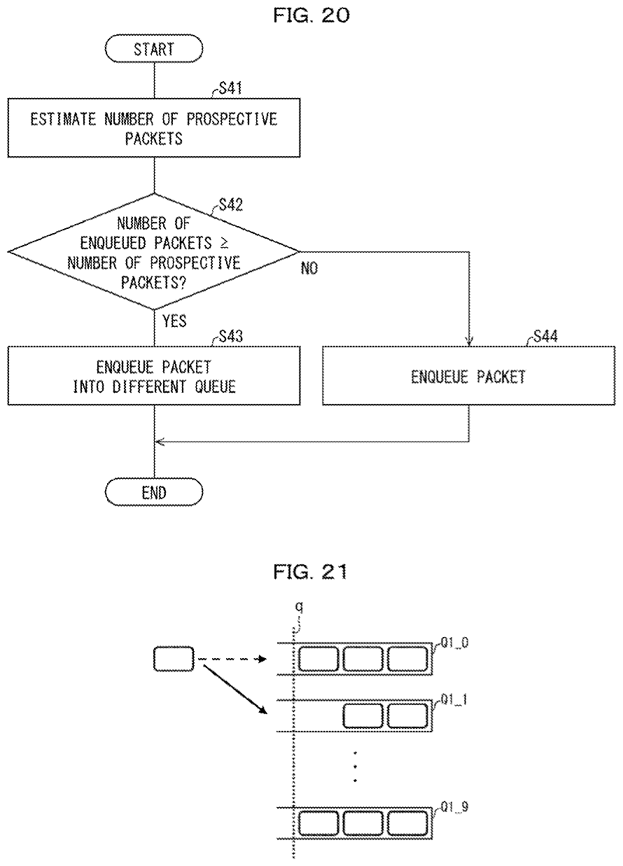

FIG. 20 is a flowchart illustrating another example of the enqueuing process. In a step S41, the enqueue unit 12 estimates, for each of the queues, a current number of prospective packets with reference to the number of prospective packets which has been previously estimated for that queue.

### (Number of Prospective Packets)

Here, the term “the number of prospective packets” refers to the number of packets that are estimated to be dequeued at a dequeue timing specified for each queue. In a case where a network is not congested and packets have been dequeued at a dequeue timing of each queue, the number of prospective packets L_{i,t} in a queue i is represented, for example, as follows: L_{i,t}=min(2L_{i, t-1}, Qᵢ). Here, “L_{i, t-1}” is the number of prospective packets estimated in one previous cycle, and “Qᵢ” is a maximum number of packets that can be stored in the queue i.

Meanwhile, in a case where packets stored in the queue i have not all been dequeued due to congestion of the network, the number of prospective packets L_{i,t} in the queue i is, for example, represented as follows: L_{i,t}=αL_{i, t-1}+(1−α)b_{i,t}. Here, “a” is a coefficient that satisfies 0≤α≤1, “b_{i,t}” is the number of packets dequeued from the queue i, and “L_{i,t-1}” is the number of prospective packets estimated in one previous cycle. In other words, for example, in a case where a packet(s) has been previously dequeued for each queue and a packet(s) remains in that queue, the enqueue unit 12 further refers to the number of packets which have been previously dequeued and estimates a current number of prospective packets. For example, the enqueue unit 12 may calculate the number of prospective packets from an average number of packets observed during T seconds in the past. In this case, it is possible to adapt to instantaneous change in communication quality by shortening the time T, and it is possible to adapt to long-term change in communication quality by increasing the time T.

In steps S42 through S44, the enqueue unit 12 specifies, in accordance with the number of enqueued packets in a queue corresponding to a sending timing associated with a packet, a queue into which the packet is to be enqueued. Here, the queue corresponding to the transmission timing is a queue for which a dequeue timing corresponding to the transmission timing is specified. First, in the step S42, the enqueue unit 12 determines whether or not the number of enqueued packets is equal to or greater than the number of prospective packets. In a case where the number of enqueued packets is equal to or greater than the number of prospective packets (YES in the step S42), the enqueue unit 12 proceeds to a process of the step S43. Meanwhile, in a case where the number of enqueued packets is less than the number of prospective packets (NO in the step S42), the enqueue unit 12 proceeds to a process of the step S44.

In the step S43, the enqueue unit 12 enqueues a packet to be enqueued into a queue different from the queue. In other words, the enqueue unit 12 carries out dequeuing at a dequeue timing specified for each of the queues, and estimates the number of prospective packets that are sendable to the network. Furthermore, in a case where the number of enqueued packets is equal to or greater than the number of prospective packets in a queue for which a dequeue timing corresponding to a sending timing associated with the packet is specified, the enqueue unit 12 enqueues the packet into a queue that is different from the queue.

In the step S44, the enqueue unit 12 enqueues, into the queue, a packet which is to be enqueued. In other words, in a case where the number of enqueued packets is less than the number of prospective packets in a queue for which a dequeue timing corresponding to a sending timing associated with the packet is specified, the enqueue unit 12 enqueues the packet into the queue.

As described above, the enqueue unit 12 determines, based on the number of enqueued packets enqueued in a queue corresponding to a sending timing (request time u) associated with a packet, whether or not to enqueue the packet into the queue in the steps S42 through S44. Here, the queue corresponding to the transmission timing is a queue for which a dequeue timing corresponding to the transmission timing is specified.

FIG. 21 is a diagram for explaining an enqueuing process that is carried out by the enqueue unit 12 in the present process example. In the example illustrated in FIG. 21, in a case where the usable band varies, the enqueue unit 12 calculates the number q of prospective packets in the queue Q1_0 that is to be subjected to enqueuing (step S41 in FIG. 20). In a case where the number of enqueued packets in the queue Q1_0 is equal to or greater than the number q of prospective packets, the enqueue unit 12 enqueues a packet which has been scheduled to be enqueued into the queue Q1_0 into another queue Q1_1 at a level identical with that of the queue Q1_0. Here, the queue Q1_0 is an example of a “first queue” according to this specification and the queue Q1_1 is an example of a “second queue” according to this specification. The dequeue timing specified for the queue Q1_1 is later than the dequeue timing specified for the queue Q1_0. That is, in the example illustrated in FIG. 21, in a case where the number of enqueued packets in the queue corresponding to the sending timing associated with the packet is equal to or greater than the number q of prospective packets, the enqueue unit 12 enqueues the packet into a queue for which a specified dequeue timing is later than the dequeue timing specified for the queue.

In the example illustrated in FIG. 21, in a case where the packet has been enqueued into the queue Q1_0 (see the dotted line in FIG. 21), a packet which has not been sent at the sending timing is caused to wait until a next dequeue timing of the queue Q1_0 comes. Therefore, a delay time increases by at least 10 [ms]. Meanwhile, in a case where the enqueue unit 12 enqueues the packet into the queue Q1_1 instead of the queue Q1_0 (see the solid line in FIG. 21), the delay time can be suppressed to 9 [ms], and an increase in delay time can be suppressed.

### <Effect of Information Processing Apparatus>

As described above, the information processing apparatus 1A according to the present example embodiment employs the configuration in which the dequeue unit 13 sends, in accordance with a priority order corresponding to an amount of delay from the sending timing associated with the packet, a packet which has not been sent at the sending timing. According to the information processing apparatus 1A of the present example embodiment, by sending, in accordance with the priority order corresponding to the amount of delay, a packet which has not been sent, it is possible to prevent an amount of delay from being excessively large in packet transmission control.

The information processing apparatus 1A according to the present example embodiment employs the configuration in which: the enqueue unit 12 determines, based on the number of enqueued packets enqueued in a queue corresponding to the sending timing associated with the packet, whether or not to enqueue the packet into the queue. Therefore, according to the information processing apparatus 1A of the present example embodiment, it is possible to prevent an amount of delay from being excessively large in packet transmission control, as compared with a case where whether or not to carry out enqueuing is not determined based on the number of enqueued packets.

The information processing apparatus 1A according to the present example embodiment employs the configuration in which: the enqueue unit 12 carries out dequeuing at a dequeue timing specified for each of the queues; the enqueue unit 12 estimates the number of prospective packets that are sendable to the network; and the enqueue unit 12 specifies, in accordance with the number of enqueued packets in a queue corresponding to the sending timing associated with the packet, a queue into which the packet is to be enqueued. Therefore, according to the information processing apparatus 1A of the present example embodiment, it is possible to prevent an amount of delay from being excessively large in packet transmission control, as compared with a case where a queue into which a packet is to be enqueued is not specified in accordance with the number of prospective packets.

The information processing apparatus 1A according to the present example embodiment employs the configuration in which: the enqueue unit 12 estimates, for each of the queues, a current number of prospective packets with reference to the number of prospective packets which has been previously estimated for that queue. According to the information processing apparatus 1A of the present example embodiment, by determining a queue to be subjected to enqueuing using the estimated number of prospective packets, it is possible to bring about an effect that an increase in delay and delay jitter can be reduced in packet transmission control, even in a case where a band that is usable for a network varies.

The information processing apparatus 1A according to the present example embodiment employs the configuration in which: the plurality of queues are classified into a plurality of levels in accordance with delay granularity; and in a case where the number of enqueued packets in a first queue which corresponds to the sending timing associated with the packet is equal to or greater than the number of prospective packets, the enqueue unit 12 enqueues the packet into a second queue which is at a level identical with that of the first queue. Therefore, according to the information processing apparatus 1A of the present example embodiment, it is possible to bring about an effect that an increase in delay and delay jitter can be reduced in packet transmission control.

The information processing apparatus 1A according to the present example embodiment employs the configuration of further including: a calculation unit 15 that calculates, with a calculation technique corresponding to an application type of a packet which has been acquired by the acquisition unit 11, a sending timing of the packet. Therefore, according to the information processing apparatus 1A of the present example embodiment, it is possible to bring about an effect that packet transmission control can be carried out in accordance with an application type.

### [Software Implementation Example]

The functions of part of or all of the packet control apparatus 10, the information processing apparatus 1A, and the packet control system 1 (hereinafter, referred to as “packet control apparatus 10 and the like”) can be realized by hardware such as an integrated circuit (IC chip) or can be alternatively realized by software.

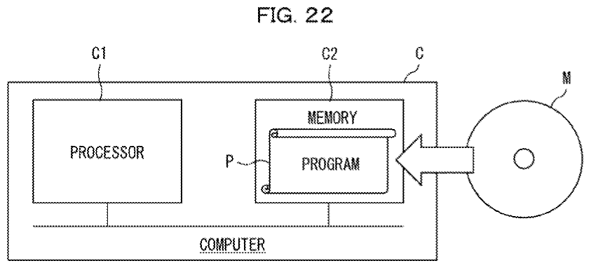

In the latter case, each of the packet control apparatus 10 and the like is realized by, for example, a computer that executes instructions of a program that is software realizing the foregoing functions. FIG. 22 illustrates an example of such a computer (hereinafter, referred to as “computer C”). The computer C includes at least one processor C1 and at least one memory C2. The memory C2 stores a program P for causing the computer C to function as the packet control apparatus 10 and the like. In the computer C, the processor C1 reads the program P from the memory C2 and executes the program P, so that the functions of the packet control apparatus 10 and the like are realized.

As the processor C1, for example, it is possible to use a central processing unit (CPU), a graphic processing unit (GPU), a digital signal processor (DSP), a micro processing unit (MPU), a floating point number processing unit (FPU), a physics processing unit (PPU), a microcontroller, or a combination of these. The memory C2 can be, for example, a flash memory, a hard disk drive (HDD), a solid state drive (SSD), or a combination of these.

Note that the computer C can further include a random access memory (RAM) in which the program P is loaded when the program P is executed and in which various kinds of data are temporarily stored. The computer C can further include a communication interface for carrying out transmission and reception of data with other apparatuses. The computer C can further include an input-output interface for connecting input-output apparatuses such as a keyboard, a mouse, a display and a printer.

The program P can be stored in a non-transitory tangible storage medium M which is readable by the computer C. The storage medium M can be, for example, a tape, a disk, a card, a semiconductor memory, a programmable logic circuit, or the like. The computer C can obtain the program P via the storage medium M. The program P can be transmitted via a transmission medium. The transmission medium can be, for example, a communications network, a broadcast wave, or the like. The computer C can obtain the program P also via such a transmission medium.

### [Additional Remark 1]

The present invention is not limited to the foregoing example embodiments, but may be altered in various ways by a skilled person within the scope of the claims. For example, the present invention also encompasses, in its technical scope, any example embodiment derived by appropriately combining technical means disclosed in the foregoing example embodiments.

### [Additional Remark 2]

Some of or all of the foregoing example embodiments can also be described as below. Note, however, that the present invention is not limited to the following example aspects.

### (Supplementary Note 1)

A packet control system including: an acquisition section that acquires a packet which is associated with a sending timing; an enqueue section that enqueues the packet into any of a plurality of queues in accordance with the sending timing which is associated with the packet; and a sending section that dequeues a packet from each of the plurality of queues in accordance with a dequeue timing specified for the queue and that sends the packet to a network, the number of packets to be sent to the network by the sending section being restricted in accordance with a band that is usable for the network, and the sending section sending, after the sending timing associated with the packet, a packet that is not sent at the sending timing.

### (Supplementary Note 2)

The packet control system described in supplementary note 1, in which: the sending section sends, in accordance with a priority order corresponding to an amount of delay from the sending timing associated with the packet, a packet which has not been sent at the sending timing.

### (Supplementary Note 3)

The packet control system described in supplementary note 1 or 2, in which: the enqueue section determines, based on the number of enqueued packets enqueued in a queue corresponding to the sending timing associated with the packet, whether or not to enqueue the packet into the queue.

### (Supplementary Note 4)

The packet control system described in supplementary note 3, in which: the enqueue section carries out dequeuing at a dequeue timing specified for each of the queues; the enqueue section estimates the number of prospective packets that are sendable to the network; and the enqueue section specifies, in accordance with the number of enqueued packets in a queue corresponding to the sending timing associated with the packet, a queue into which the packet is to be enqueued.

### (Supplementary Note 5)

The packet control system described in supplementary note 4, in which: the enqueue section estimates, for each of the queues, a current number of prospective packets with reference to the number of prospective packets which has been previously estimated for that queue.

### (Supplementary Note 6)

The packet control system described in supplementary note 4 or 5, in which: the plurality of queues are classified into a plurality of levels in accordance with delay granularity; and in a case where the number of enqueued packets in a first queue which corresponds to the sending timing associated with the packet is equal to or greater than the number of prospective packets, the enqueue section enqueues the packet into a second queue which is at a level identical with that of the first queue.

### (Supplementary Note 7)

The packet control system described in any one of supplementary notes 1 through 6, further including: a calculation section that calculates, with a calculation technique corresponding to an application type of a packet which has been acquired by the acquisition section, a sending timing of the packet.

### (Supplementary Note 8)

A packet control method including: acquiring a packet which is associated with a sending timing; enqueuing the packet into any of a plurality of queues in accordance with the sending timing which is associated with the packet; and dequeuing a packet from each of the plurality of queues in accordance with a dequeue timing specified for the queue and sending the packet to a network, the number of packets to be sent to the network in the sending being restricted in accordance with a band that is usable for the network, and, after the sending timing associated with the packet, a packet that is not sent at the sending timing being sent in the sending.

### (Supplementary Note 9)

The packet control method described in supplementary note 8, in which: in accordance with a priority order corresponding to an amount of delay from the sending timing associated with the packet, a packet which has not been sent at the sending timing is sent in the sending.

### (Supplementary Note 10)

The packet control method described in supplementary note 8 or 9, in which: based on the number of enqueued packets enqueued in a queue corresponding to the sending timing associated with the packet, whether or not to enqueue the packet into the queue is determined in the enqueuing.

### (Supplementary Note 11)

The packet control method described in supplementary note 10, in which: in the enqueuing, dequeuing is carried out at a dequeue timing specified for each of the queues; in the enqueuing, the number of prospective packets that are sendable to the network is estimated; and in the enqueuing, in accordance with the number of enqueued packets in a queue corresponding to the sending timing associated with the packet, a queue into which the packet is to be enqueued is specified.

### (Supplementary Note 12)

The packet control method described in supplementary note 11, in which, in a case where the number of enqueued packets is less than the number of prospective packets in a queue for which a dequeue timing corresponding to a sending timing associated with the packet is specified, the packet is enqueued into the queue in the enqueuing.

### (Supplementary Note 13)

The packet control method described in supplementary note 11 or 12, in which: the plurality of queues are classified into a plurality of levels in accordance with delay granularity; and in a case where the number of enqueued packets in a first queue which corresponds to the sending timing associated with the packet is equal to or greater than the number of prospective packets, the packet is enqueued in the enqueuing into a second queue which is at a level identical with that of the first queue.

### (Supplementary Note 14)

The packet control method described in claim 8, further including: calculating, with a calculation technique corresponding to an application type of a packet which has been acquired, a sending timing of the packet.

### (Supplementary Note 15)

A packet control apparatus including: an acquisition section that acquires a packet which is associated with a sending timing; an enqueue section that enqueues the packet into any of a plurality of queues in accordance with the sending timing which is associated with the packet; and a sending section that dequeues a packet from each of the plurality of queues in accordance with a dequeue timing specified for the queue and that sends the packet to a network, the number of packets to be sent to the network by the sending section being restricted in accordance with a band that is usable for the network, and the sending section sending, after the sending timing associated with the packet, a packet that is not sent at the sending timing.

### (Supplementary Note 16)

The packet control apparatus described in supplementary note 15, in which: the sending section sends, in accordance with a priority order corresponding to an amount of delay from the sending timing associated with the packet, a packet which has not been sent at the sending timing.

### (Supplementary Note 17)

The packet control apparatus described in supplementary note 15 or 16, in which: the enqueue section determines, based on the number of enqueued packets enqueued in a queue corresponding to the sending timing associated with the packet, whether or not to enqueue the packet into the queue.

### (Supplementary Note 18)

The packet control apparatus described in supplementary note 17, in which: the enqueue section carries out dequeuing at a dequeue timing specified for each of the queues; the enqueue section estimates the number of prospective packets that are sendable to the network; and the enqueue section specifies, in accordance with the number of enqueued packets in a queue corresponding to the sending timing associated with the packet, a queue into which the packet is to be enqueued.

### (Supplementary Note 19)

The packet control apparatus described in supplementary note 18, in which: the enqueue section estimates, for each of the queues, a current number of prospective packets with reference to the number of prospective packets which has been previously estimated for that queue.

### (Supplementary Note 20)

The packet control apparatus described in supplementary note 18 or 19, in which: the plurality of queues are classified into a plurality of levels in accordance with delay granularity; and in a case where the number of enqueued packets in a first queue which corresponds to the sending timing associated with the packet is equal to or greater than the number of prospective packets, the enqueue section enqueues the packet into a second queue which is at a level identical with that of the first queue.

### [Additional Remark 3]

Furthermore, some of or all of the foregoing example embodiments can also be expressed as below.

A packet control system including at least one processor, the at least one processor executing: an acquisition process of acquiring a packet which is associated with a sending timing; an enqueuing process of enqueuing the packet into any of a plurality of queues in accordance with the sending timing which is associated with the packet; and a sending process of dequeuing a packet from each of the plurality of queues in accordance with a dequeue timing specified for the queue and sending the packet to a network, the number of packets to be sent to the network in the sending process being restricted in accordance with a band that is usable for the network, and, after the sending timing associated with the packet, a packet that is not sent at the sending timing being sent in the sending process.

Note that the packet control system can further include a memory. The memory can store a program for causing the at least one processor to execute the acquisition process, the enqueuing process, and the sending process. The program can be stored in a computer-readable non-transitory tangible storage medium.

Although the present invention has been described with reference to the foregoing example embodiments and the like, the present invention is not limited to the foregoing example embodiments. Various modifications which can be understood by a person skilled in the art within the scope of the present invention can be made to the configurations and details of the present invention. At least one or more functions of the packet control apparatus 10 and the like described above may be executed in a plurality of different information processing apparatuses that are installed at and connected to any locations on a network, that is, may be executed in so-called cloud computing.

### REFERENCE SIGNS LIST

1: Packet control system
1A: Information processing apparatus
10: Packet control apparatus
10A: Control unit
11: Acquisition unit
12: Enqueue unit
15: Calculation unit
13: Dequeue unit
16: Queue control unit
17: Sending unit

What is claimed is:

1. A packet control system comprising at least one processor, the at least one processor carrying out:
an acquisition process of acquiring a packet which is associated with a sending timing;
an enqueuing process of enqueuing the packet into any of a plurality of queues in accordance with the sending timing which is associated with the packet; and
a sending process of dequeuing a packet from each of the plurality of queues in accordance with a dequeue timing specified for the queue and sending the packet to a network,
the number of packets to be sent to the network in the sending section process being restricted in accordance with a band that is usable for the network, and
in the sending process, the at least one processor sending, after the sending timing associated with the packet, a packet that is not sent at the sending timing.

2. The packet control system as set forth in claim 1, wherein:
in the sending process, the at least one processor sends, in accordance with a priority order corresponding to an amount of delay from the sending timing associated with the packet, a packet which has not been sent at the sending timing.

3. The packet control system as set forth in claim 1, wherein:
in the enqueuing process, the at least one processor determines, based on the number of enqueued packets enqueued in a queue corresponding to the sending timing associated with the packet, whether or not to enqueue the packet into the queue.

4. The packet control system as set forth in claim 3, wherein:
in the enqueuing process, the at least one processor carries out dequeuing at a dequeue timing specified for each of the queues;
in the enqueuing process, the at least one processor estimates the number of prospective packets that are sendable to the network; and
in the enqueuing process, the at least one processor specifies, in accordance with the number of enqueued packets in a queue corresponding to the sending timing associated with the packet, a queue into which the packet is to be enqueued.

5. The packet control system as set forth in claim 4, wherein:
in the enqueuing process, the at least one processor estimates, for each of the queues, a current number of prospective packets with reference to the number of prospective packets which has been previously estimated for that queue.

6. The packet control system as set forth in claim 4, wherein:
the plurality of queues are classified into a plurality of levels in accordance with delay granularity; and
in a case where the number of enqueued packets in a first queue which corresponds to the sending timing associated with the packet is equal to or greater than the number of prospective packets, in the enqueuing process, the at least one processor enqueues the packet into a second queue which is at a level identical with that of the first queue.

7. The packet control system as set forth in claim 1, wherein:
the at least one processor further carries out a calculation process of calculating, with a calculation technique corresponding to an application type of a packet which has been acquired in the acquisition process, a sending timing of the packet.

8. A packet control method comprising:
acquiring, by at least one processor, a packet which is associated with a sending timing;
enqueuing, by the at least one processor, the packet into any of a plurality of queues in accordance with the sending timing which is associated with the packet; and
dequeuing, by the at least one processor, a packet from each of the plurality of queues in accordance with a dequeue timing specified for the queue and sending, by the at least one processor, the packet to a network,
the number of packets to be sent to the network in the sending being restricted in accordance with a band that is usable for the network, and
after the sending timing associated with the packet, a packet that is not sent at the sending timing being sent in the sending.

9. The packet control method as set forth in claim 8, wherein:
in accordance with a priority order corresponding to an amount of delay from the sending timing associated with the packet, a packet which has not been sent at the sending timing is sent by the at least one processor in the sending.

10. The packet control method as set forth in claim 8, wherein:
based on the number of enqueued packets enqueued in a queue corresponding to the sending timing associated with the packet, whether or not to enqueue the packet into the queue is determined by the at least one processor in the enqueuing.

11. The packet control method as set forth in claim 10, wherein:
in the enqueuing, dequeuing is carried out by the at least one processor at a dequeue timing specified for each of the queues;
in the enqueuing, the number of prospective packets that are sendable to the network is estimated by the at least one processor; and
in the enqueuing, in accordance with the number of enqueued packets in a queue corresponding to the sending timing associated with the packet, a queue into which the packet is to be enqueued is specified by the at least one processor.

12. The packet control method as set forth in claim 11, wherein:
in the enqueuing, for each of the queues, a current number of prospective packets is estimated by the at least one processor with reference to the number of prospective packets which has been previously estimated for that queue.

13. The packet control method as set forth in claim 11, wherein:
the plurality of queues are classified into a plurality of levels in accordance with delay granularity; and
in a case where the number of enqueued packets in a first queue which corresponds to the sending timing associated with the packet is equal to or greater than the number of prospective packets, the packet is enqueued by the at least one processor in the enqueuing into a second queue which is at a level identical with that of the first queue.

14. The packet control method as set forth in claim 8, further comprising:
calculating, by the at least one processor and with a calculation technique corresponding to an application type of a packet which has been acquired, a sending timing of the packet.

15. A packet control apparatus comprising at least one processor, the at least one processor carrying out:
an acquisition process of acquiring a packet which is associated with a sending timing;
an enqueuing process of enqueuing the packet into any of a plurality of queues in accordance with the sending timing which is associated with the packet; and
a sending process of dequeuing a packet from each of the plurality of queues in accordance with a dequeue timing specified for the queue and sending the packet to a network,
the number of packets to be sent to the network in the sending process being restricted in accordance with a band that is usable for the network, and
in the sending process, the at least one processor sending, after the sending timing associated with the packet, a packet that is not sent at the sending timing.

16. The packet control apparatus as set forth in claim 15, wherein:
in the sending process, the at least one processor sends, in accordance with a priority order corresponding to an amount of delay from the sending timing associated with the packet, a packet which has not been sent at the sending timing.

17. The packet control apparatus as set forth in claim 15, wherein:
in the enqueuing process, the at least one processor determines, based on the number of enqueued packets enqueued in a queue corresponding to the sending timing associated with the packet, whether or not to enqueue the packet into the queue.

18. The packet control apparatus as set forth in claim 17, wherein:
in the enqueuing process, the at least one processor carries out dequeuing at a dequeue timing specified for each of the queues;
in the enqueuing process, the at least one processor estimates the number of prospective packets that are sendable to the network; and
in the enqueuing process, the at least one processor specifies, in accordance with the number of enqueued packets in a queue corresponding to the sending timing associated with the packet, a queue into which the packet is to be enqueued.

19. The packet control apparatus as set forth in claim 18, wherein:
in the enqueuing process, the at least one processor estimates, for each of the queues, a current number of prospective packets with reference to the number of prospective packets which has been previously estimated for that queue.

20. The packet control apparatus as set forth in claim 18, wherein:
the plurality of queues are classified into a plurality of levels in accordance with delay granularity; and
in a case where the number of enqueued packets in a first queue which corresponds to the sending timing associated with the packet is equal to or greater than the number of prospective packets, in the enqueuing process, the at least one processor enqueues the packet into a second queue which is at a level identical with that of the first queue.
